(19) United States
(12) Patent Application Publication
(10) Pub. No.: US 2008/0249685 A1
(43) Pub. Date: Oct. 9, 2008

(54) Steering Control Apparatus and Method

(75) Inventors: Kazuo Hara, Kanagawa (JP); Takaaki Eguchi, Kanagawa (JP)

Correspondence Address: YOUNG & BASILE, P.C., 3001 WEST BIG BEAVER ROAD, SUITE 624, TROY, MI, 48084, US

(73) Assignee: nissan Motor Co., Ltd., Kanagawa (JP)

(21) Appl. No.: 10/575,401

(22) PCT Filed: Dec. 13, 2005
(86) PCT No.: PCT/IB2005/003770

§ 371 Date: Apr. 10, 2006

(30) Foreign Application Priority Data
Dec. 14, 2004 (JP) 2004-361986

(51) Int. Cl. B62D 6/04

(52) U.S. Cl. 701/42

(57) ABSTRACT

A vehicle steering controller includes a turning unit which is mechanically separated from a steering unit, which receives the steering input, and turns the road wheels corresponding to the steering input. The controller also includes a reaction force motor that applies a steering reaction force corresponding to the turning state of the turning unit to the steering unit, a hands-off detection sensor that detects whether the steering unit is in the hands-off state, and a steering reaction force correction component that reduces the steering reaction force from that in the hands-on state when the hands-off state is detected.

### BACKGROUND

The present invention relates to the field of steering control for vehicles and in particular to electronic (or “steer-by-wire”) steering control systems.

In the field of steer-by-wire systems, a steering reaction force sensor is placed on the tie rod, and the road surface reaction force detected by the steering reaction force sensor is added to the steering reaction torque, so that the force acting from the road surface on the tires is reflected on the steering reaction force torque.

In order to reliably transmit the road surface feel to the driver in a steer-by-wire system, a control value corresponding to the road surface reaction force is added to the steering reaction force torque. For example, in the technology described in Japanese Kokai Patent Application No. Hei 10[1998]-217988, in the steering force computation unit, on the basis of the detection result of the steering force sensor, steering force T applied to the steering shaft is computed. At the same time, control value (aT) for rotating the steering shaft in the direction of applied steering force T is computed. In the steering reaction force computation unit, on the basis of the detection result of the steering reaction force sensor, steering reaction force F applied to the steering shaft is computed. In the steering shaft motor controller, on the basis of these computational results of the steering force computation unit and steering reaction force computation unit, rotation control value Mm of the steering shaft is computed using the following equation, and the reaction force control signal corresponding to rotation control value Mm is output to steering shaft motor. In the following equation, Gm represents the gain coefficient indicating the gain of the output signal.

Mm=Gm*(aT−F)

### SUMMARY

If steering reaction force Mm is set to an appropriate value for steering, when the hands are released, the steering wheel may go past the neutral position and overshoot.

The present invention discloses a vehicle steering controller for controlling road wheels on a vehicle including a turning unit which receives steering input and turns the road wheels in accordance with the steering input, a steering unit mechanically separated from the turning unit, a steering reaction force applicator adapted for applying a steering reaction force corresponding to a turning state of the turning unit on the steering unit, a hands-free sensor adapted for detecting whether the steering unit is in a hands-off state or a hands-on state, and a steering reaction force correction component adapted for reducing the steering reaction force in the hands-on state when the hands-off state is detected.

A method for controlling the road wheels of a vehicle is also disclosed including turning the road wheels from a steering input via a turning unit, mechanically separating the turning unit from a steering unit, applying a steering reaction force corresponding to a turning state of the turning unit on the steering unit, detecting whether the steering unit is in a hands-on or hands-off state, and reducing the steering reaction force in the hands-on state when the hands-off state is detected.

In the foregoing, preferred embodiments of the present invention were explained. However, the present invention is not limited to the embodiments 1-4. As long as the essence of the invention is observed, changes may be made to the design of the present invention.

### BRIEF DESCRIPTION OF THE DRAWINGS

The description herein makes reference to the accompanying drawings wherein like reference numerals refer to like parts throughout the several views, and wherein:

FIG. 1 is an overall system diagram illustrating the vehicle steering controller according to the first embodiment;

FIG. 2 is a flow chart illustrating the setting control process of a road surface reaction force gain executed by a controller according to the first embodiment;

FIG. 3 is a graph used to set a road surface reaction force coefficient D corresponding to the values of torque sensors on the steering wheel side;

FIG. 4 is a graph used to set a steering angle gain corresponding to a steering angle;

FIG. 5 is a graph used to set a steering angle acceleration gain corresponding to a steering angle acceleration;

FIG. 6 is a graph used to set a steering angle velocity gain corresponding to a steering angle velocity;

FIG. 7 is a graph used to set a road surface reaction force gain corresponding to a road surface reaction force in a hands-on state;

FIG. 8 is a graph illustrating with the overshoot problem in the hands-off state of the earlier technology;

FIG. 9A is a graph illustrating the steering reaction force torque with respect to the steering angle in the hands-on state;

FIG. 9B is a graph illustrating the steering reaction force torque with respect to the steering angle in the hands-off state;

FIG. 10 is a graph illustrating the process of preventing overshoot in the hands-off state in the first embodiment;

FIG. 11 is a flow chart illustrating a control process for the setting steering angle gain executed by the controller in the second embodiment;

FIG. 12 is a graph used to set the steering angle coefficient in the second embodiment and the steering angle acceleration coefficient in the third embodiment; and

FIG. 13 is a graph used to set the steering angle acceleration coefficient in the fourth embodiment.

### DETAILED DESCRIPTION

In the embodiments disclosed below, it is possible to provide a reliable road feel to the driver by means of a steering reaction force torque corresponding to the road surface reaction force. Also, in the hands-off state, the steering reaction force torque is set smaller than that in the hands-on state, so that an appropriate restoration can be effected, thereby avoiding overshoot.

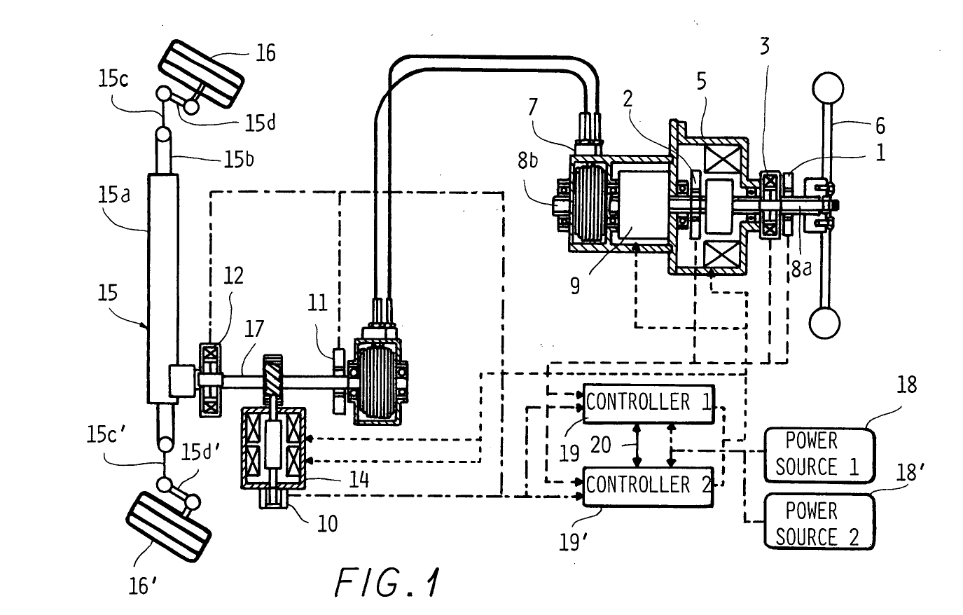

FIG. 1 is an overall system diagram illustrating the vehicle steering controller of the first embodiment. The vehicle steering controller of the first embodiment includes a steering unit, backup device, turning unit, and controller.

The steering unit has a steering angle sensor 1 (means for detecting the steering angle), an encoder 2, torque sensors 3 (means for detecting the steering torque), and a reaction force motor 5 (means for applying the steering reaction force).

The steering angle sensor 1 is a means for detecting the angular position of steering wheel 6. It is set on column shaft 8a that bonds cable column 7 and steering wheel 6. That is, steering angle sensor 1 is placed between steering wheel 6 and torque sensors 3 and is unaffected by the change in angle due to the twisting of torque sensors 3, so that it can detect the steering angle. In the steering angle sensor 1, an absolute type resolver (not shown) or the like is used.

The torque sensors 3 form a double system and are arranged between the steering angle sensor 1 and the reaction force motor 5. Each torque sensor 3 has a torsion bar extending in the axial direction, a first shaft connected to one end of the torsion bar and coaxial to the torsion bar, a second shaft connected to the other end of the torsion bar and coaxial to the torsion bar and the first shaft, a first magnetic body fixed to the first shaft, a second magnetic body fixed to the second shaft, a coil facing the first magnetic body and the second magnetic body, and a third magnetic body that surrounds the coil and forms a magnetic circuit together with the first magnetic body and second magnetic body. The coil detects the torque from the output signal on the basis of the inductance that changes corresponding to the relative displacement between the first magnetic body and the second magnetic body on the basis of the twisting of the torsion bar.

The reaction force motor 5 is a reaction force actuator that imparts a reaction force to steering wheel 6. It is made of a 1-rotor/1-stator type electric motor with the column shaft 8a as the rotary shaft. Its housing is fixed at an appropriate location of the vehicle body. A brushless motor is used as the reaction force motor 5, with encoder 2 and a Hall IC (not shown in the figure), which are required for use with a brushless motor. Here, if only a Hall IC is used, although it will still be possible to drive the motor, nevertheless there will be small variations in the output torque, and the feel of the steering reaction force will be poor. In order to effect smoother control of the reaction force, encoder 2 is placed on the shaft of column shaft 8a to control the motor. As a result, the small torque variations can be reduced, and the steering reaction force feel is improved. Also, a resolver can be used in place of encoder 2.

The auxiliary unit is composed of a cable column 7 and a clutch 9. The clutch 9 is arranged between column shaft 8a and pulley shaft 8b; an electromagnetic clutch is used in the first embodiment. After it is engaged, the clutch 9 connects column shaft 8a, the input shaft, to pulley shaft 8b, the output shaft. The clutch 9 mechanically transmits the steering torque from steering wheel 6 to steering unit 15.

The cable column 7 has a mechanical backup mechanism that can play the part of the column shaft in transmitting torque while it detours to avoid interference with the element included between the steering unit and the turning unit in backup state when the clutch 9 is engaged. In the structure of cable column 7, two interior cables, each end of which is fixed to a reel, are wound onto the two reels, and the two ends of the exterior sheath in which two interior cables are inserted are fixed to two reel housings.

The steering unit includes an encoder 10, a steering angle sensor 11, a torque sensors 12, (means for detecting the road surface reaction force), steering motors 14, steering unit 15, and steered road wheels 16, 16′.

The steering angle sensor 11 and torque sensors 12 are mounted on pinion shaft 17, on one end of which the pulley of cable column 7 is attached, and on the other end of which a pinion gear is formed. As steering angle sensor 11, an absolute type resolver or the like, which detects the rotational velocity of the shaft, can be used. Also, like the torque sensors 3, torque sensors 12, form a double system that detects torque from changes in inductance. Then, steering angle sensor 11 is set on the side of cable column 7, and torque sensors 12 are set on the side of steering unit 15. As a result, when the steering angle is detected by steering angle sensor 11, it is unaffected by the change in the angle due to the twisting of torque sensors 12.

The steering motors 14, have a structure in which a pinion gear engaged to the worm gear set at the central position between steering angle sensor 11 of the pinion shaft 17 and torque sensors 12, is set on the motor shaft, so that a steering torque is applied to pinion shaft 17 when the motor is ON. The steering motors 14, form a double system with a 1-rotor/2-stator structure. They are brushless motors that form first steering motor 14 and second steering motor 14. Also, similar to the reaction force motor 5, due to the adoption of the brushless motors, encoder 10 and a Hall IC (not shown in the figure) is used.

The steering unit 15 has a structure in which left/right steered road wheels 16 turn as pinion shaft 17 rotates. It has rack shaft 15b that forms a rack gear engaged with the pinion gear of pinion shaft 17 and inserted in rack tube 15a, tie rods 15c, 15c′ fixed to the two ends of rack shaft 15b extending in the left/right direction of the vehicle, and knuckle arms 15d, 15d′ having one end fixed to the tie rods 15c, 15c′ and the other end fixed to steered wheels 16, 16′.

The controller has a double system structure composed of two controllers 19, 19′ that perform processing and arithmetic operations with two power sources 18, 18′.

The controller 19 receives the detected signals from the following parts: steering angle sensor 1, encoder 2, torque sensors 3, and the Hall IC of the reaction force device, as well as the encoder 10, steering angle sensor 11, torque sensors 12, Hall IC, and vehicle speed sensor 21 of the steering device.

On the basis of the detection values of the various sensors, controller 19 sets the control values of reaction force motor 5 and steering motor 14, and controls and drives each of steering motors 14. Also, during ordinary system conditions, controller 19 releases clutch 9. Otherwise, the system engages clutch 9 to establish a mechanical connection between steering wheel 6 and steered wheels 16, 16′.

Setting the reaction force motor control value is discussed hereinafter. In controller 19, the following Equation 1 is used to set control value Th of the reaction force motor 5.

Th=Kp×0+Kd×d0/dt+Kdd×d²0/dt²+D×Kf×F (1)

Here, θ represents the steering angle, Kp represents the steering angle gain, Kd represents the steering angle velocity gain, Kdd represents the steering angle acceleration gain, D represents the road surface reaction force coefficient, and Kf represents the road surface reaction force gain.

In Equation 1, the first, second and third terms on the right-hand side set the control value of the steering reaction force on the basis of steering angle θ, and the fourth term on the right-hand side sets the control value on the basis of road surface reaction force F, so that it can reflect the influence of the force acting from the road surface on the tires to the steering reaction force torque. Also, steering angle acceleration d²θ/d²t and steering angle velocity dθ/dt are computed from the detected value of steering angle sensor 1 (corresponding to the means for detecting the acceleration computing means and the means for detecting the steering angle velocity).

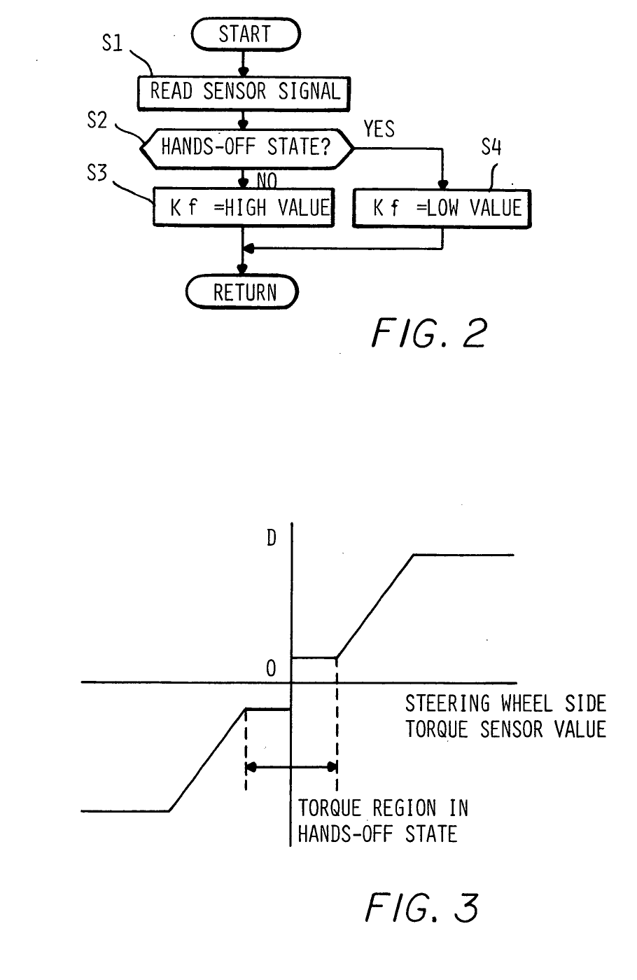

Setting the control value corresponding to the hands-off state is discussed hereinafter. In Equation 1, road surface reaction force feedback gain Kf that determines the value of the reflected steering reaction force torque on the basis of the road surface reaction force changes value as a function of the steering state. FIG. 2 is a flow chart illustrating the process flow in setting and controlling road surface reaction force gain Kf executed by controller 19 in first embodiment.

In step S1, the various sensor signals are read, and process control then goes to step S2. In step S2, from the sensor signals of torque sensors 3 on the steering wheel side read in step S1, it is determined whether the system is in the hands-off state (it corresponds to the hands-off detection means). If YES, it goes to step S4. If NO, it goes to step S3. Judgment of the hands-off state is made when the sensor signals of torque sensors 3 are below a prescribed level. Here, the prescribed value refers to the hysteresis characteristics of torque sensors 3, and it is set from the hysteresis range when the torque input corresponds to zero.

In step S3, because it was determined that the system is not in the hands-off state in step S2, road surface reaction force gain Kf is set at prescribed High value (corresponding to the steering reaction force correction means), and it then returns.

In step S4, because it was determined that the system is in the hands-off state in step S2, road surface reaction force gain Kf is set at prescribed Low value smaller than the High value, and it then returns.

In the hands-off state, road surface reaction force gain Kf is set smaller, and the control value based on road surface reaction force F is smaller so that an appropriate steering wheel restoration can be obtained. On the other hand, in the hands-on state, road surface reaction force gain Kf is set larger and the control value based on road surface reaction force F is larger so that an appropriate steering reaction force can be obtained.

Setting of control value corresponding to the steering torque in the hands-on state is discussed hereinafter. In Equation 1, in the hands-on state, road surface reaction force coefficient D that determines the steering reaction force torque based on the road surface reaction force changes value corresponding to the steering torque.

FIG. 3 is a diagram illustrating a graph used to set road surface reaction force coefficient D corresponding to the value of torque sensors 3 on the steering wheel side. The road surface reaction force coefficient D is set such that it has a prescribed minimum value in the range of the torque sensor value corresponding to the hands-off state, and it has a larger value when the absolute value of the torque sensor value becomes larger. Also, in order to prevent the steering reaction force torque from becoming too large, when the absolute value of the torque sensor value exceeds a prescribed level, it becomes a prescribed maximum value.

Setting of control value corresponding to the steering state is now discussed. In Equation 1, steering angle gain Kp for setting the control value of the steering reaction force on the basis of steering angle θ changes as a function of steering angle θ. As shown in FIG. 4, steering angle gain Kp is set such that it is larger for larger absolute value of steering angle θ. Also, steering angle gain Kp is set to have a larger value for a higher vehicle speed.

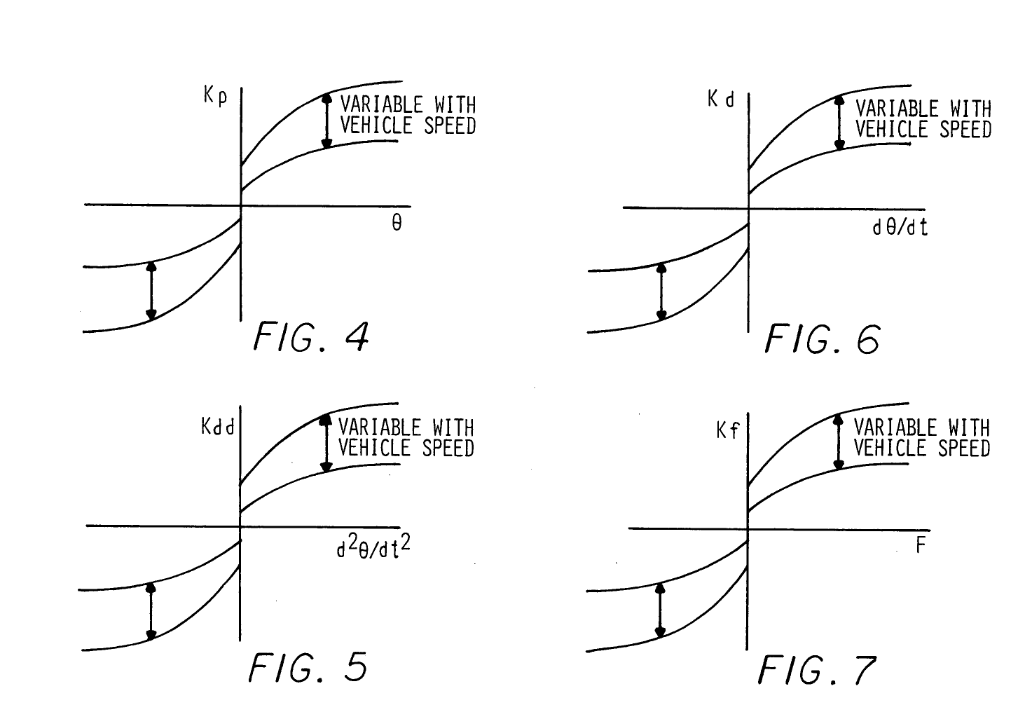

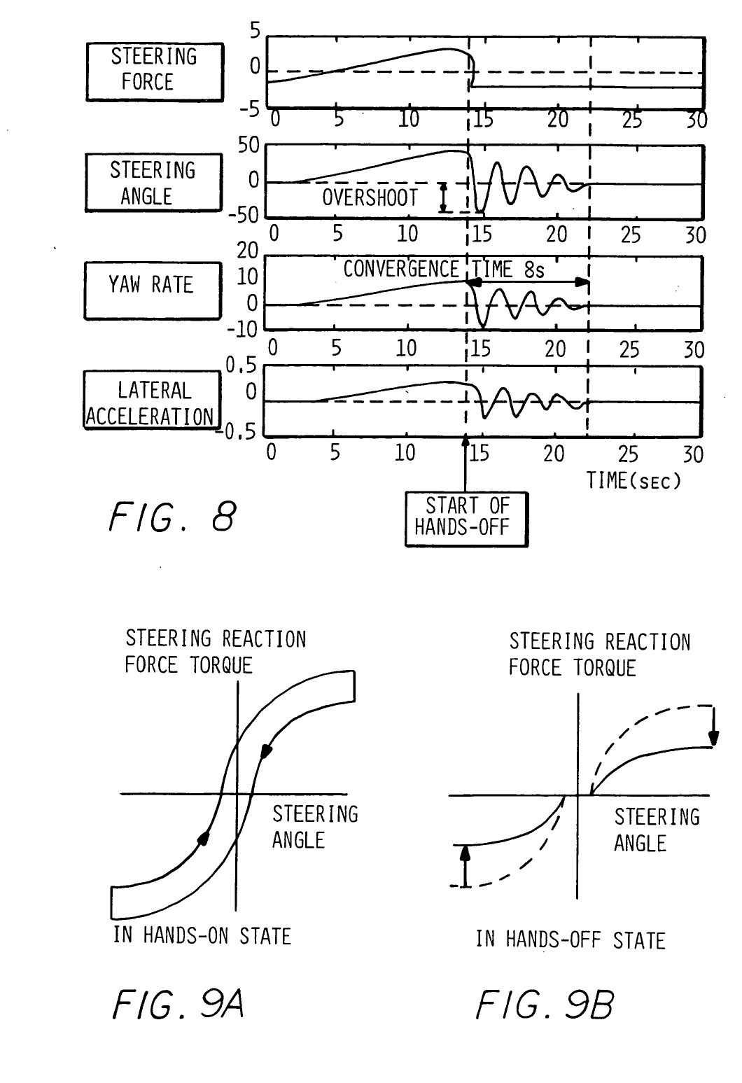

Also, in Equation 1, steering angle acceleration gain Kdd for setting the change in the steering reaction force based on steering angle acceleration d²θ/d²t varies as a function of steering angle acceleration d²θ/d²t. As shown in FIG. 5, steering angle acceleration gain Kdd is set such that it becomes larger when the absolute value of steering angle acceleration d²θ/dt² becomes larger. Also, steering angle acceleration gain Kdd is set such that it is larger when the vehicle speed is higher.

Also, in Equation 1, steering angle velocity gain Kd for setting the control value of the steering reaction force on the basis of steering angle velocity dθ/dt changes as a function of steering angle velocity dθ/dt. As shown in FIG. 6, steering angle gain Kd is set such that it is larger for larger absolute value of steering angle velocity dθ/dt. Also, steering angle gain Kd is set to have a larger value for a higher vehicle speed.

Setting of control value corresponding to road surface reaction force is now discussed. In Equation 1, road surface reaction force gain Kf is not limited to the two values of High and Low. In addition, it may change as a function of road surface reaction force F. In this case, road surface reaction force gain Kf is set such that it is larger when the absolute value of road surface reaction force F is larger (FIG. 7).

In conventional steer-by-wire systems, in order to reliably transmit the road surface feel to the driver, a control value corresponding to the road surface reaction force is added to the steering reaction force torque. On the basis of the detection result of a steering force sensor, steering force T applied to the steering shaft is computed. At the same time, control value (aT) for rotating the steering shaft in the direction of applied steering force T is computed. In the steering reaction force computation unit, on the basis of the detection result of the steering reaction force sensor, steering reaction force F applied to the steering shaft is computed. In the steering shaft motor controller, on the basis of these computational results of the steering force computation unit and steering reaction force computation unit, rotation control value Mm of the steering shaft is computed using the following equation, and the reaction force control signal corresponding to rotation control value Mm is output to steering shaft motor. In the following equation, Gm represents the gain coefficient indicating the gain of the output signal.

Mm=Gm×(a T−F) (2)

However, in the related art, when steering reaction force Mm is set to an appropriate value for steering, when the hands are released, the steering wheel restoration force becomes too large, so that the steering wheel goes past the neutral position and overshoots.

The process of changing the steering reaction force corresponds to the hands-off/hands-on states. In consideration of this problem, for the vehicle steering controller in the first embodiment, the steering reaction force torque corresponding to the road surface reaction force is reduced in the hands-on state as compared with that in the hands-off state, so that the problem is solved.

FIG. 9(a) shows the steering reaction force torque with respect to the steering angle in the hands-on state, and FIG. 9(b) shows the steering reaction force torque with respect to the steering angle in the hands-off state. In the hands-on state, road surface reaction force gain Kf is set to the High value, so that even if the steering wheel is in return state, the steering reaction force torque can still be transmitted to the driver corresponding to the steering angle.

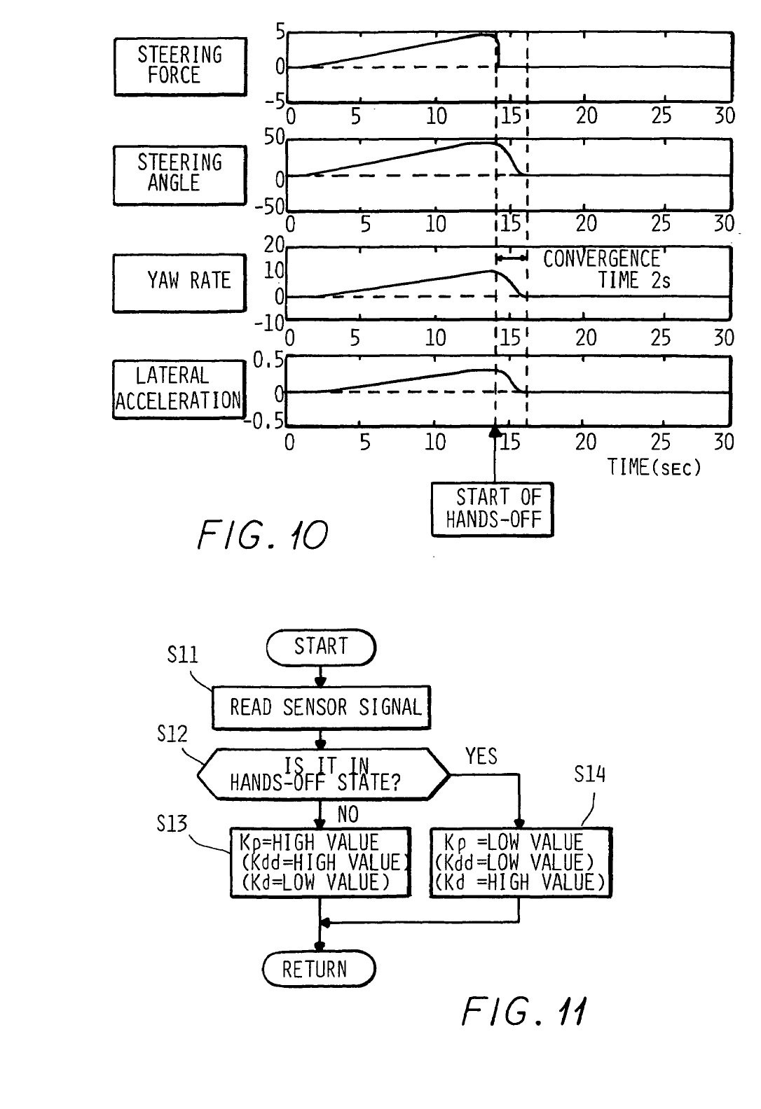

On the other hand, in the hands-off state, because road surface reaction force gain Kf is set at the Low value, steering reaction force Kf×F corresponding to road surface reaction force F is smaller than that in the hands-on state. As a result, the steering reaction force torque corresponding to the steering angle in the hands-off state becomes smaller than that in the hands-on state. As shown in FIG. 10, because it is possible to prevent the generation of overshoot after the driver's hands are removed from the steering wheel, the time that the hands are removed, convergence of the yaw rate, lateral acceleration, or other vehicle state value changes can be made shorter than that in the related art (convergence time 2s).

Process of changing the steering reaction force corresponds to the steering torque. In the first embodiment, in the hands-on state, the steering reaction force torque is larger when the steering torque is larger. Consequently, in switching between the hands-off state and hands-on state, D is changed smoothly instead of stepwise between the Low value and High value of coefficient Kf, so that it is possible to realize both a more natural steering wheel recovery performance and a good transmission of the road surface feel.

For the vehicle steering controller in first embodiment, the following effects can be realized. Because the device has a turning unit 3 that is mechanically separated from the steering unit 1, which receives the steering input, and the steered road wheels 16, 16′ corresponding to the steering input, the reaction force motor 5 that applies a steering reaction force corresponding to the turning state of turning unit 3 with respect to steering unit 1, a hands-off detection means that detects whether steering unit 1 is in the hands-off state, and a steering reaction force correction means that reduces the steering reaction force with respect to that in the hands-on state. Consequently, it is possible to realize both an appropriate recovery in the hands-off state and reliable transmission of the road surface feel to the driver in the hands-on state.

The system has torque sensors 12 that detect road surface reaction force F, and reaction force motor 5 applies steering reaction force Kf×F corresponding to the road surface reaction force, and when the hands-off state is detected, the steering reaction force correction means reduces the steering reaction force corresponding to the road surface reaction force with Kf set at the Low value. Consequently, in the hands-off state, an appropriate steering wheel recovery performance is realized, and, in the hands-on state, the road surface feel can be transmitted accurately to the driver.

The controller torque sensors 3 that detect the steering torque. When the hands-off state is not detected, the steering reaction force correction means reduces the steering reaction force corresponding to the road surface reaction force for a smaller steering torque. Consequently, in switching between the hands-off and the hands-on state, smooth switching can be realized, and it is possible to realize both a natural steering wheel recovery performance and a good transmission of the road surface feel.

The second embodiment is an example in which the quantity of reflected steering reaction force torque is changed on the basis of the steering angle. As the structure of the second embodiment is the same as that of the first embodiment, it will not be explained again.

In the second embodiment, in controller 19, control value Th of reaction force motor 5 is set on the basis of Equation 3 below.

Th=Kp×0+Kd×d0/dt+Kdd×d²θ/dt²+kf×F (3)

FIG. 11 is a flow chart illustrating the process for setting and controlling the steering angle gain Kp executed by controller 19 in the second embodiment. In steps S1 and S2, the same process used in steps S1 and S2 of FIG. 2 is performed, so that it will not be explained again.

In step S13, because it was determined in step S12 that the system is not in the hands-off state, steering angle gain Kp is set at the prescribed High value (corresponding to a steering reaction force correction means), and it then returns.

In step S14, because it was determined in step S12 that the system is in the hands-off state, steering angle gain Kp is set at the Low value smaller than the High value, and it then returns.

That is, because steering angle gain Kp is the elastic moment component for returning steering wheel 6 to the neutral point (the neutral position), in the hands-off state, it is set at a smaller value so that there is an appropriate steering wheel restoration to prevent the steering wheel from exceeding the neutral point, that is, so that it does not overshoot, while in the hands-on state, it is set larger to produce an appropriate steering reaction force torque.

As another method, one may change Kp×θ corresponding to the detection value of torque sensors 3 on the steering wheel side. In this case, on the basis of Equation 4 below, control value Th of reaction force motor 5 is computed.

Th=A×Kp×0+Kd×dθ/dt+Kdd×d²θ/dt²+D×Kf×F (4)

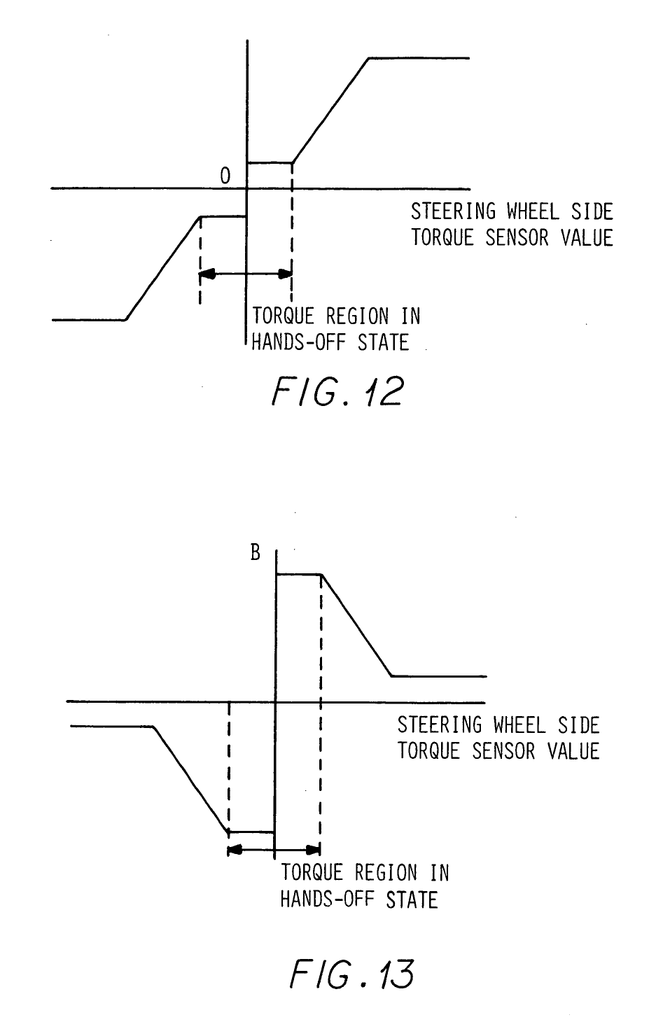

Here, A is the steering angle coefficient set proportional to the absolute value of the steering torque. As shown in FIG. 12, A has a prescribed minimum value in the range of the torque sensor value corresponding to the hands-off state, and it has a larger value when the absolute value of the torque sensor value becomes larger. Also, in order to prevent the steering reaction force torque from becoming too large, it is set so that when the absolute value of the torque sensor value exceeds a prescribed level, it assumes a prescribed maximum value.

By setting control value Th on the basis of Equation 4, steering angle coefficient A can be changed smoothly corresponding to the steering torque. Consequently, it is possible to realize a more natural steering wheel restoration and an appropriate steering reaction force torque. Also, when steering wheel 6 does not return to the neutral position after return of the steering angle, one may increase Kp.

As explained in the first embodiment, by reducing elastic reaction force Kp in the hands-off state, it is possible to reduce the overshoot in steering wheel recovery and to improve the converging property of the vehicle behavior. Also, when the restoration force is insufficient and steering wheel 6 does not return to the neutral point, with a residual steering angle remaining, it is possible to increase Kp in order to reduce the residual steering angle.

For the vehicle steering controller in the second embodiment, in addition to effect of the first embodiment, it has the following effects.

The system has steering angle sensor 1 that detects steering angle θ. The reaction force motor 5 applies steering reaction force Kp×θ corresponding to steering angle θ. When the hands-off state is detected, steering reaction force correction means reduces steering reaction force Kp×θ corresponding to steering angle θ. Consequently, it is possible to reduce the overshoot in the hands-off state and to improve the converging performance of the vehicle behavior.

The third embodiment is an example illustrating the change in the steering reaction force torque reflection quantity on the basis of the steering angle acceleration in the hands-off state. The structure of the third embodiment is the same as that of the first embodiment, so that it will not be explained again.

In the third embodiment, in Equation 1 for setting the control value of reaction force motor 5, steering angle acceleration gain Kdd is changed between the hands-off state and the hands-on state. In the hands-on state, steering angle acceleration gain Kdd is set at prescribed value High, and, in the hands-off state, steering angle acceleration gain Kdd is set at the Low value smaller than the High value.

That is, Kdd is the inertial torque component. The smaller the value of Kdd, the higher the converging frequency of steering wheel 6. Consequently, the value of Kdd is smaller so that there is an appropriate steering wheel restoration in the hands-off state, and the value of Kdd is set larger so that there is an appropriate steering inertial feel in the hands-on state.

As another method, one may also adopt a scheme in which Kdd×d²θ/dt² changes corresponding to the value detected by torque sensors 3, 3 on the steering wheel side. In this case, control value Th of reaction force motor 5 is computed on the basis of Equation 5 below.

Th=A×Kp×θ+Kd×dθ/dt+C×Kdd×d²θ/dt²+D×Kf×F (5)

Here, C represents the steering angle acceleration coefficient set proportional to the absolute value of the steering torque. As shown in FIG. 12, steering angle acceleration coefficient C is a prescribed minimum value in the range of the torque sensor corresponding to the hands-off state. In the hands-on state, the larger the absolute value of the torque sensor value, the larger the value of C. Also, in order to prevent the steering reaction force torque from becoming too large, it is set such that it has a prescribed maximum value when the absolute value of the torque sensor value exceeds a prescribed level.

By setting control value Th on the basis of Equation 5, it is possible to change steering angle acceleration coefficient C smoothly corresponding to the steering torque, so that it is possible to realize a more natural steering wheel recovery performance and appropriate steering reaction force torque.

For the vehicle steering controller in the third embodiment, in addition to effect of the first embodiment, the following effects can be realized.

The controller of the third embodiment has a steering angle acceleration detection means that detects the steering angle acceleration. The reaction force motor 5 applies steering reaction force kdd×d²t/dt² corresponding to steering angle acceleration d²t/dt². When the steering reaction force correction means detects the hands-off state, steering reaction force kdd×d²t/dt² is made smaller corresponding to steering angle acceleration d²t/dt². As a result, in the hands-off state, the converging frequency of steering wheel 6 becomes higher, and the converging performance can be improved.

The fourth embodiment is an example in which the steering reaction force torque reflection quantity is changed on the basis of the steering angle velocity in the hands-off state. Also, since the structure of the fourth embodiment is the same as that of the first embodiment, it will not be explained again.

In the fourth embodiment, in Equation 1 for setting the control value of reaction force motor 5, steering angle velocity gain Kd is changed between the hands-off state and the hands-on state. In the hands-on state, steering angle velocity gain Kd is set at the prescribed High value, and in the hands-off state, steering angle velocity gain Kd is set at the Low value, smaller than the High value.

That is, Kd represents the viscous torque component. The larger this component, the higher the converging damping of steering wheel 6 in the hands-off state. Consequently, in the hands-off state, the value is set larger to have an appropriate steering wheel recovery performance. In the hands-on state, the value is set smaller to have an appropriate steering viscous feel.

As another method, Kd×dθ/dt may be changed corresponding to the value detected by torque sensors 3 on the steering wheel side. In this case, control value Th of reaction force motor 5 is computed with following Equation 6.

Th=A×Kp×θ+B×Kd×dθ/dt+C×Kdd×d²θ/dt²+D×Kf×F (6)

Here, B represents the steering angle velocity coefficient set proportional to the absolute value of the steering torque. As shown in FIG. 13, steering angle velocity coefficient B is set such that it has a prescribed minimum value in the range of the torque sensor value corresponding to the hands-off state, and it has a larger value when the absolute value of the torque sensor value becomes larger in the hands-on state. Also, in order to prevent the steering reaction force torque from becoming too large, when the absolute value of the torque sensor value exceeds a prescribed level, it takes on a prescribed maximum value.

By setting control value Th on the basis of Equation 6, steering angle velocity coefficient B is changed smoothly corresponding to the steering torque, and it is possible to realize a more natural steering wheel recovery performance and an appropriate steering torque. Also, in Equation 6, in order to have steering angle θ in the reducing direction in the hands-off state, the second term on the right-hand side is opposite in sign to the other terms.

For the vehicle steering controller in the fourth embodiment, in addition to effect 1 in the first embodiment, the following effects can be realized.

There is steering angle velocity detection means that detects steering angle velocity dθ/dt, and reaction force motor 5 applies steering reaction force Kd×dθ/dt corresponding to steering angle velocity dθ/dt, and when the hands-off state is detected, steering reaction force correction means reduces the steering reaction force corresponding to steering angle velocity dθ/dt, so that in the hands-off state, it is possible to increase the converging damping of steering wheel 6 and to improve the convergence performance.

In the foregoing, preferred embodiments of the present invention were explained. However, the present invention is not limited to the embodiments 1-4. As long as the essence of the invention is observed, changes may be made to the design of the present invention.

This application is based on Japanese Patent Application No. 2004-361986, filed Dec. 14, 2004 in the Japanese Patent Office, the entire contents of which are hereby incorporated by reference.

What is claimed is:

1. A steering control device for use in a vehicle having a steering wheel that receives steering input, and an electronically-controlled steering unit that turns the vehicle's wheels over a road surface based on the position of the steering wheel, comprising:
a reaction force device coupled to the steering wheel and responsive to a control signal to apply a steering reaction force to the steering wheel;
a hands-free sensor adapted to generate a signal indicative of whether the steering wheel is in a hands-on state or a hands-off state; and
a controller adapted to vary the control signal in response to the hands-free sensor signal to reduce the steering reaction force applied when the hands-off state is indicated relative to the steering reaction force applied when the hands-on state is indicated.

2. The steering control device of claim 1, further comprising:
a road surface reaction force sensor adapted to generate a signal indicative of road surface reaction force, wherein the reaction force device is further adapted to apply the steering reaction force corresponding to the indicated road surface reaction force; and wherein the controller is further adapted to reduce the steering reaction force corresponding to the indicated road surface reaction force when the hands-off state is indicated.

3. The steering control device of claim 1, further comprising a steering angle detection sensor adapted to generate a signal indicative of the steering angle of the steering wheel; wherein the steering reaction force device is further adapted to apply a steering reaction force corresponding to the steering angle; and wherein the controller is further adapted to reduce the reaction force corresponding to the indicated steering angle when the hands-off state is indicated.

4. The steering control device of claim 1, further comprising a steering angle acceleration detection sensor adapted to generate a signal indicative of the steering angle acceleration; wherein the steering reaction device applies a steering reaction force corresponding to the indicated steering angle acceleration; and wherein the controller is further adapted to reduce the reaction force corresponding to the indicated steering angle acceleration when the hands-off state is indicated.

5. The steering control device of claim 1, further comprising a steering angle velocity detection sensor adapted to generate a signal indicative of the steering angle velocity; wherein the steering reaction device applies a steering reaction force corresponding to the indicated steering angle velocity; and wherein the controller is further adapted to reduce the reaction force corresponding to the indicated steering angle velocity when the hands-off state is indicated.

6. The steering control device of claim 1, further comprising a steering torque detection sensor adapted to generate a signal indicative of steering torque; and wherein the controller is further adapted to reduce the reaction force when the indicated steering torque decreases and the hands-off state is not indicated.

7. A vehicle having road wheels, comprising:
a steering unit;
an electronically-controlled turning unit responsive to the steering unit which turns the road wheels based on the position of the steering unit;
a steering reaction force applicator adapted for applying a steering reaction force to the steering unit;
a hands-free sensor adapted for detecting whether the steering unit is in a hands-off state or a hands-on state; and
a steering reaction force correction component adapted for reducing the steering reaction force applied when the hands-off state is detected relative to the steering reaction force applied when the hands-on state is detected.

8. The vehicle of claim 7, further comprising:
a road surface reaction force sensor adapted for detecting the road surface reaction force; wherein the steering reaction force applicator applies a steering reaction force corresponding to the road surface reaction force; and wherein the steering reaction force correction component reduces the steering reaction force corresponding to the road surface reaction force when the steering unit is in the hands-off state.

9. The vehicle of claim 7, further comprising a steering angle detection sensor for detecting the steering angle of the steering wheel; wherein the steering reaction force applicator applies a steering reaction force corresponding to the steering angle; and wherein the steering reaction force correction component reduces the steering reaction force corresponding to the steering angles when the hands-off state is detected.

10. The vehicle of claim 7, further comprising a steering angle acceleration detection sensor for detecting the steering angle acceleration; wherein the steering reaction force applicator applies a steering reaction force corresponding to the steering angle acceleration; and wherein the steering reaction force correction component reduces the steering reaction force corresponding to the steering angles when the hands-off state is detected, but reference steering angle acceleration.

11. The vehicle of claim 7, further comprising a steering angle velocity detection sensor adapted for detecting the steering angle velocity; wherein the steering reaction force applicator applies a steering reaction force corresponding to the steering angle velocity, and wherein the steering reaction force correction component reduces the steering reaction force corresponding to the steering angle velocity when the hands-off state is detected.

12. The vehicle of claim 7, further comprising a steering torque detection sensor adapted for detecting steering torque; wherein the steering reaction force correction component reduces the steering reaction force when the steering torque becomes smaller if the hands-off state is not detected.

13. A vehicle for controlling road wheels of the vehicle comprising:
means for turning the road wheels in response to a steering input of a steering unit;
means for applying a steering reaction force to the steering unit;
means for detecting whether the steering unit is in a hands-on or hands-off state; and
means for reducing the steering reaction force in the hands-on state when the hands-off state is detected.

14. A method for controlling the road wheels of a vehicle comprising:
turning the road wheels from a steering input via a steering unit;
applying a steering reaction force to the steering unit;
detecting whether the steering unit is in a hands-on or hands-off state; and
reducing the steering reaction force applied when the hands-off state is detected relative to the steering reaction force applied when the hands-on state is detected.

15. The method of claim 14, further comprising;
detecting a road surface reaction force;
applying a steering reaction force to the steering unit corresponding to the road surface reaction force; and
reducing the steering reaction force corresponding to the road surface reaction force when the hands-off state is detected.

16. The method of claim 14, further comprising:
detecting the steering angle;
applying the steering reaction force to the steering unit corresponding to the steering angle; and
reducing the steering reaction force corresponding to the steering angle when the hands-off state is detected.

17. The method of claim 14, further comprising:
detecting the steering angle acceleration;
applying the steering reaction force to the steering unit corresponding to the steering angle acceleration; and
reducing the steering reaction force corresponding to the steering angle acceleration when the hands-off state is detected.

18. The method of claim 14, further comprising:
detecting the steering angle velocity;
applying the steering reaction force to the steering unit corresponding to the steering angle velocity; and
reducing the steering reaction force corresponding to the steering angle velocity when the hands-off state is detected.

19. The method of claim 14, further comprising:
detecting the steering torque;
applying the steering reaction force to the turning means corresponding to the steering torque; and
reducing the steering reaction force corresponding to the steering torque when the hands-off state is detected.
